(19) United States
(12) Patent Application Publication
(10) Pub. No.: US 2019/0297075 A1
(43) Pub. Date: Sep. 26, 2019

(54) REPEATED SECONDARY USER AUTHENTICATION

(71) Applicant: CA, Inc., New York, NY (US)

(72) Inventors: Mohammed Mujeeb Kaladgi, Bangalore (IN); Ruqiya Nikhat Kaladgi, Bangalore (IN); Yashwant Ramkishan Sawant, Parbhani (IN); Sandeep Banisetti, Srikakulam (IN)

(21) Appl. No.: 15/936,407

(22) Filed: Mar. 26, 2018

(51) Int. Cl. H04L 29/06; G06F 21/34; H04L 9/32; H04L 9/08

(52) U.S. Cl. CPC H04L 63/0853; G06F 21/34; H04L 63/18; H04L 9/0863; H04L 9/3228

(57) ABSTRACT

Techniques are disclosed relating to performing repeated secondary user authentication. An authentication computer system may receive, from a server computer system, a request to authenticate a user to a service that is provided by the server computer system. The authentication computer system may cause an out-of-band authentication message to be sent to an authentication application associated with the user. The authentication computer system may receive an authentication response including an authentication code that is generated, without user input, by the authentication application. The authentication server may determine whether to authenticate the authentication response and send an authentication indication to the server computer system.

### BACKGROUND

### Technical Field

This disclosure relates generally to user authentication, and more particularly to repeated secondary user authentication systems.

### Description of the Related Art

Server systems, such as web server systems, application server systems, etc., may provide various resources to an end user. For example, an application server may provide access to software applications to various end users. The server system may limit access to its resources to only authorized end users. One method of limiting access is to require end users to provide credentials, such as a username and password, to the server system, which the server system may use to authenticate the requesting end user prior to providing access to the resource. In some instances, however, the use of such credentials may be susceptible to various vulnerabilities (e.g., phishing attacks), presenting security concerns. Thus, in various instances, it may be desirable to utilize secondary user authentication techniques.

### SUMMARY

Techniques are disclosed relating to performing repeated secondary user authentication. An authentication computer system may receive, from a server computer system, a request to authenticate a user to a service that is provided by the server computer system. The authentication computer system may cause an authentication message to be sent to an authentication application associated with the user, where the authentication message includes a one-time passcode and a particular key identifier associated with the service for the user. Further, the authentication message may be out-of-band with respect to the service provided by the server computer system to the user. The authentication computer system may receive an authentication response including an authentication code that is generated, without user input, by the authentication application based on the one-time passcode and a particular key associated with the user for the service. The authentication server may determine whether to authenticate the authentication response and send an authentication indication to the server computer system.

### BRIEF DESCRIPTION OF THE DRAWINGS

FIG. 1 is a block diagram illustrating an example system for performing repeated secondary user authentication, according to some embodiments.

FIG. 2 is a block diagram illustrating an example authentication application, according to some embodiments.

FIG. 3 is a block diagram illustrating an example user device, according to some embodiments.

FIG. 4 is a block diagram illustrating an example authentication system, according to some embodiments.

FIG. 5 is a flow diagram illustrating an example method for performing repeated secondary user authentication, according to some embodiments.

FIG. 6 is a flow diagram illustrating an example method for keeping a user authenticated to a service provided by server system, according to some embodiments.

FIG. 7 is a block diagram illustrating an example computer system, according to some embodiments.

### DETAILED DESCRIPTION

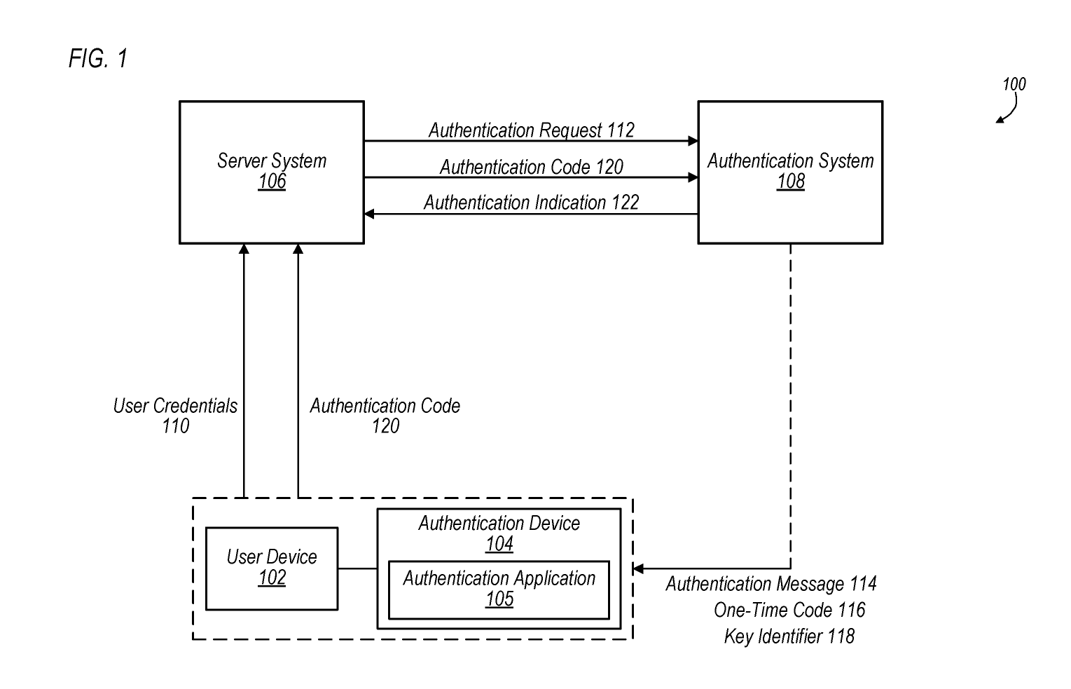

Referring to FIG. 1, a block diagram illustrating a system 100 is depicted, according to some embodiments. In the embodiment of FIG. 1, system 100 includes user device 102, authentication device 104, server system 106, and authentication system 108. Note that, although shown in direct connection, one or more of user device 102, authentication device 104, server system 106, or authentication system 108 may be connected via one or more communication networks (not shown for clarity).

In various embodiments, server system 106 may be configured to provide services (e.g., software applications, email services, etc.) to various users, such as a user of user device 102. For example, in one embodiment, server system 106 may be an email server that may be remotely accessed by a user and allows the user to view and send emails, etc. In various instances, server system 106 may limit access to the services it provides only to authorized users (e.g., to protect sensitive data, etc.).

A server system may limit access to its services according to various techniques. For example, a server system may require that a user provide valid user credentials (e.g., username, password, PIN code, etc.) to access its services. Such a single authorization factor, however, may present various shortcomings. For example, in the event that a user's credentials are compromised (e.g., through a phishing attack), an unauthorized user may then be able to access the service to the same extent as the authorized user, thus exposing potentially sensitive information and functionality to the unauthorized user.

In some instances, a server system may implement a second authentication factor before authorizing a user to access its services. For example, a server system may send (or may cause an authentication entity to send) a one-time passcode to a user (e.g., via email, text message, etc.), which the user may then provide (e.g., by manually entering the code into a web browser) back to the server system to verify her identity.

Such approaches, however, also suffer from various shortcomings. For example, the process of manually entering a one-time passcode is error prone, particularly if the code is long. Accordingly, such one-time passcodes are typically short, easily entered alphanumeric strings (e.g., a four-digit PIN code), rather than long, more cryptographically secure codes. Further, even if a user does successfully provide a one-time passcode to server system 106, such an event only serves to verify the identity of the user at the beginning of the user's session with the service and does nothing to ensure the continued authentication of the user. Thus, should the user session become compromised after the user has provided the one-time passcode, this approach could still expose the server system to unauthorized access.

In at least some embodiments, the disclosed systems and methods may mitigate these or other shortcomings by performing repeated secondary user authentication. For example, in the embodiment of FIG. 1, a user of user device 102 may attempt to access a service provided by server system 106. Prior to providing this access, server system 106 may require that the user provide user credentials 110, such as a username and password. Note that this embodiment is provided merely as an example and that any suitable credentials may be utilized without departing from the scope of this disclosure.

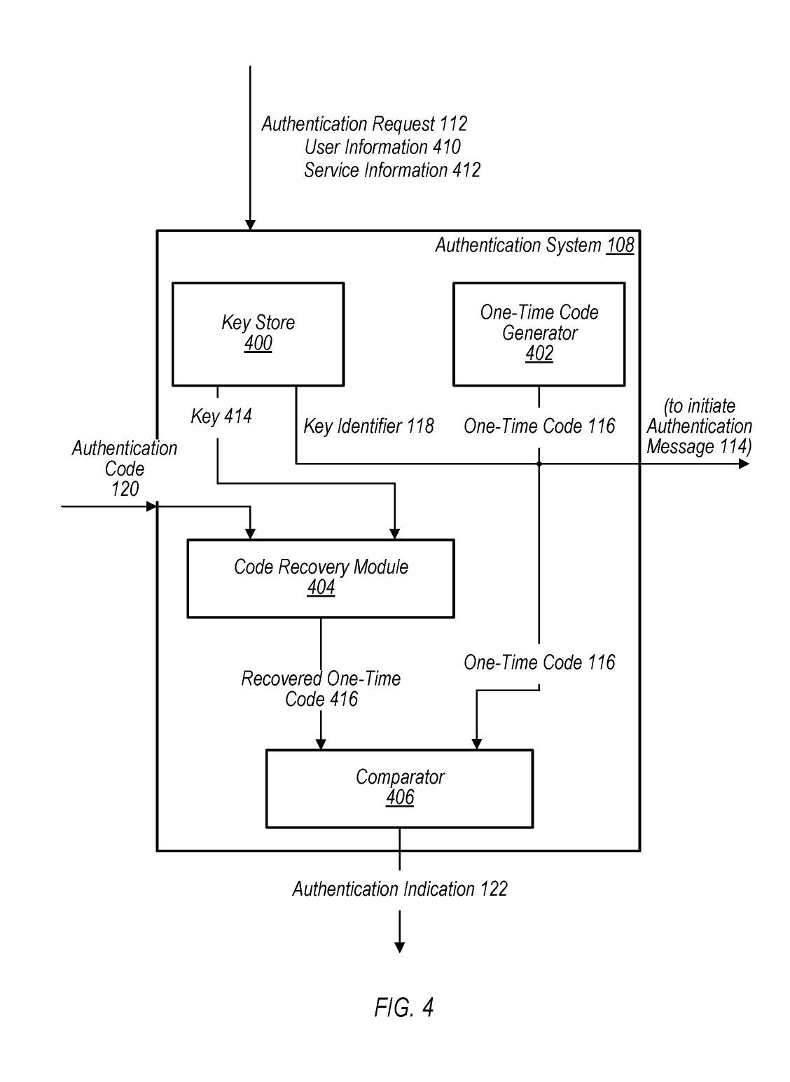

System 100 of FIG. 1 further includes authentication system 108. In various embodiments, authentication system 108 may be a computer system that is operable to perform authentication operations for various services provided by various server systems. For example, in the depicted embodiment, in response to receiving the user credentials 110, server system 106 may send an authentication request 112 to authentication system 108, requesting that authentication system 108 authenticate the user to the service provided by server system 106. As will be discussed in more detail below with reference to FIG. 4, authentication system 108 may be operable to repeatedly perform authentication operations during the course of a user session to provide continued authentication of the user to server system 106.

In response to receiving authentication request 112, authentication system 108 may be configured to cause authentication message 114 to be sent to an authentication application 105 executing on a device associated with the user (e.g., authentication device 104 or user device 102).

In various embodiments, authentication message 114 may be sent to the authentication application 105 “out-of-band” with respect to the service provided by server system 106 to user device 102. For example, in one embodiment, server system 106 may provide its service to user device 102 over the Internet, while authentication message 114 may be sent to authentication application 105 as a text message (e.g., an SMS message, MMS message, etc.) via one or more cellular networks. In the embodiment of FIG. 1, authentication application 105 is shown executing on an authentication device 104 that is configured to communicate with a user device 102 that is separate from the authentication device 104. Note that this embodiment is provided merely as an example and is not intended to limit the scope of this disclosure. As will be explained in more detail below, authentication application 105 may, in some embodiments, be operable to execute on a user device 102 by which the user is accessing the service provided by server system 106.

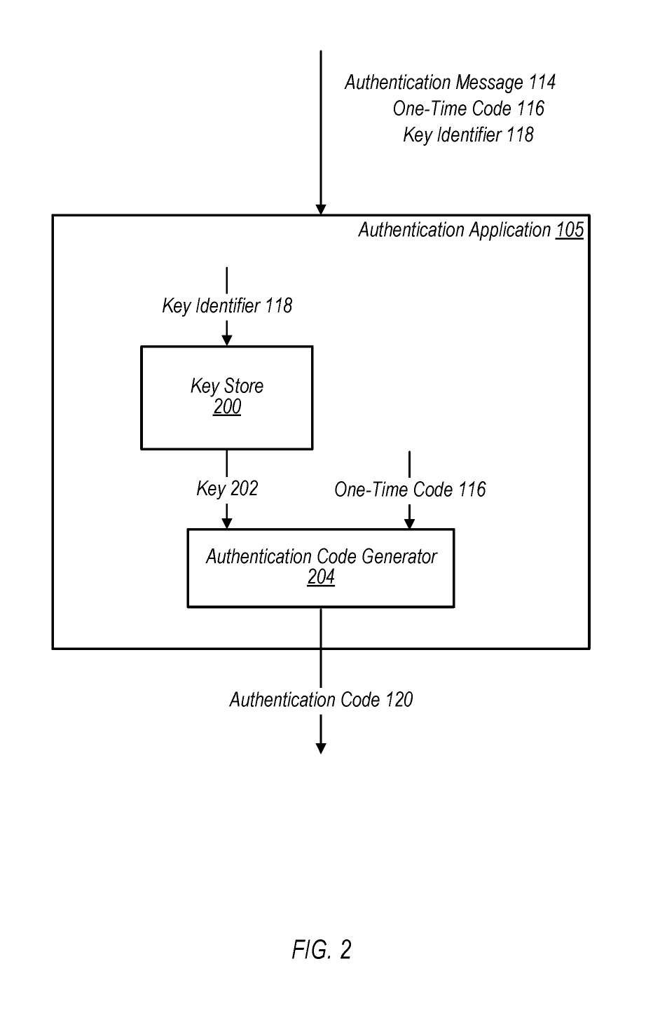

In FIG. 1, authentication message 114 includes one-time code 116 and key identifier 118. As will be explained in more detail below with reference to FIG. 2, authentication application 105 may be operable to use one-time code 116 to generate an authentication code 120, which may be provided to authentication system 108 for validation. For example, authentication application 105 may have access to various keys associated with various services and may use key identifier 118 to retrieve a particular key that corresponds to the service provided by server system 106 for the user. Having retrieved this particular key, authentication application 105 may use the particular key to perform cryptographic operations on the one-time code 116, generating authentication code 120. User device 102 may then, in various embodiments, send authentication code 120 to server system 106, which may, in turn, send the authentication code 120 to authentication system 108 for validation. Note that, in other embodiments, user device 102 may instead send authentication code 120 directly to authentication system 108, without routing it through server system 106. Further, in some embodiments, an initial authentication code 120 (e.g., the first authentication code 120 generated during a user session) may be sent to server system 106, which may then route the authentication code 120 to authentication system 108, while subsequent authentication codes 120 may be sent directly to authentication system 108.

Further, note that, in various embodiments, authentication application 105 may perform various authentication operations—e.g., receiving authentication message 114, generating authentication code 120, and outputting authentication code 120 for validation—without requiring user input. That is, these operations may be performed “in the background” of other operations (e.g., operations being performed by user device 102) such that a user of user device 102 may be unaware of the continued authentication operations taking place.

After receiving authentication code 120, authentication system 108 may be configured to determine whether to authenticate the user based on the authentication code 120, as described with reference to FIG. 4. Based on this determination, authentication system 108 may send an authentication indication 122 to server system 106, indicating whether the user is authenticated to the service. If the authentication indication indicates that the user is authenticated, server system 106 may continue to provide the service to user device 102. If, however, the authentication indication indicates that the user is not authenticated, or is no longer authenticated, server system 106 may be operable to take one or more corrective actions. For example, in some embodiments, server system 106 may cease providing the service to the user the first time that an authentication indication 122 indicates that the user has not been authenticated. In other embodiments, however, server system 106 may be configured to cease providing the service to the user after a certain number of failed authentication attempts (e.g., three), or after a certain number of consecutive failed authentication attempts. Further, in some embodiments, in response to an authentication indication 122 indicating that the user is not authenticated, server system 106 may be operable to implement one or more alternative authentication measures, such as a challenge question, an additional authentication message 114, etc.

The disclosed systems and methods for repeatedly performing secondary user authentication without requiring user input may provide various improvements to user authentication, thus improving the functioning of system 100 as a whole. For example, because authentication code 120 is generated and sent for validation without user input (e.g., without the user having to manually enter authentication code 120 into a web form), the content of authentication code 120 may be much longer and more complex than a traditional one-time passcode (e.g., a four-digit PIN code). Additionally, as will be explained below, authentication application 105 may perform various cryptographic operations on one-time code 116 to generate authentication code 120, which would not be possible or practical for a user to do manually.

Further, as one-time code 116 is received and authentication code 120 is generated without user input, the authentication operations may be repeatedly performed at various intervals without negatively impacting the user experience. For example, for a particularly sensitive service provided by server system 106, authentication system 108 may be configured to repeatedly cause updated authentication messages to be sent to authentication application 105 at a particular time interval (e.g., every 20 seconds). In some embodiments, the frequency with which the updated authentication messages 114 are sent to the authentication application 105 may be based on a security preference of the service or server system 106. For example, for particularly sensitive services (e.g., banking software applications), updated authentication messages 114 may be sent to authentication application 105 at a higher frequency (e.g., every 10 seconds). For less sensitive services (e.g., a social media website), however, updated authentication messages 114 may be sent to authentication application 105 at a lower frequency (e.g., every 60 seconds, every 5 minutes, etc.). In various embodiments, each updated authentication message may include an updated one-time code 116, with which authentication application 105 may repeatedly generate updated authentication codes 120. This, in turn, ensures to authentication system 108 and server system 106 the continued authorization of the user of user device 102 during the course of the user session, rather than simply once at the initiation of the user session.

Further, the disclosed systems and methods, in various embodiments, present various improvements over existing secondary user authentication techniques. For example, in an alternative system in which the user is required to provide user input to generate authentication codes (e.g., by requiring the user to provide a biometric (such as a fingerprint) every time an authentication code is to be generated), repeatedly performing authentication operations would not be practical, as the user would have to constantly cease using the service to generate the authentication code. In various embodiments of the present disclosure, however, the user experience with the service provided by server system 106 is not negatively impacted, since the authentication codes 120 are generated and sent in the background, and the user will not be required to cease using the service to continually enter one-time passcodes.

Thus, the disclosed systems and methods, in at least some embodiments, improve secondary user authentication by allowing for more cryptographically-secure authentication codes to be sent to authentication system 108, and for the secondary user authentication operations to be repeatedly performed in a manner that does not negatively interfere with the user experience.

Turning now to FIG. 2, a block diagram illustrating an example authentication application 105 is shown, according to some embodiments. In various embodiments, authentication application 105 may be operable to repeatedly perform authentication operations to keep a user (e.g., a user of user device 102) authenticated to a service provided by server system 106.

In some embodiments, authentication application 105 may be executed by an authentication device 104, such as a dongle or mobile communication device (e.g., a smart phone). In such embodiments, the authentication device 104 may be configured to communicate with a separate user device 102 by which the user is accessing the service provided by server system 106. For example, in one embodiment, authentication application 105 may be executed by a dongle computing device that is configured to communicate via a USB interface with separate user device 102 (e.g., a laptop) that the user is using to access the service. Note, however, that this embodiment is provided merely as an example and is not intended to limit the scope of this disclosure. For example, authentication device 104 may be any suitable computing device (such as a mobile computing device) operable to receive authentication messages 114 and execute authentication application 105. Further, in various embodiment, authentication device 104 and user device 102 may be configured to communicate via any suitable communication technique, such as near-field communications (NFC), Wi-Fi Direct, Bluetooth, etc.

In other embodiments, however, authentication application 105 may be executed by the user device 102 (e.g., a smart phone or other computing device that includes a wireless interface) by which the service is provided to the user. For example, in one embodiment, user device 102 may be a smart phone, and authentication application 105 may be executed by user device 102 without a separate authentication device 104.

In various embodiments, the computing device on which authentication application 105 is executing (whether it be user device 102 or an authentication device 104 that is separate from user device 102) includes a wireless interface that is configured to receive authentication messages 114.

In various embodiments, such a wireless interface may include one or more antennas, identity module hardware (e.g., a SIM card, R-UIM card, etc.), and any suitable wireless communication circuitry (e.g., for digital signal processing) configured to communicate via one or more various communication protocols. For example, the computing device may be configured to communicate using one or more cellular communication protocols (e.g., GSM, LTE, etc.). Further, in some embodiments, the computing device may be configured to communicate using one or more wireless networking protocol (e.g., Wi-Fi), a peer-to-peer wireless communication protocol (e.g., Bluetooth, NFC, etc.), or any other suitable wireless communication protocol, if desired.

As shown in FIG. 2, authentication message 114 may include one-time code 116 and key identifier 118. In various embodiments, authentication system 108 and authentication application 105 may utilize pairs of cryptographic keys (or simply “keys”) as part of a cryptographic scheme used to authenticate the user to the service provided by server system 106. For example, in some embodiments, authentication system 108 and authentication application 105 may implement an asymmetric-key encryption scheme in which one entity (e.g., authentication application 105 or authentication device 104) maintains a private key and the other entity (e.g., authentication system 108) maintains the corresponding public key such that communications between the two entities may be authenticated. Note, however, that this embodiment is provided merely as an example and, in other embodiments, any suitable cryptographic scheme may be implemented (e.g., any suitable symmetric-key encryption scheme). Thus, in some embodiments, key store 200 may store various keys (e.g., on a storage element of authentication device 104 or memory 304 of user device 102) for use in authentication operations for various services. In various embodiments, key identifier 118 is an identifier (e.g., an alphanumeric string) that corresponds to the service to which the user is being authenticated, and authentication application 105 may use key identifier 118 to identify and retrieve a corresponding key 202 that is stored in key store 200.

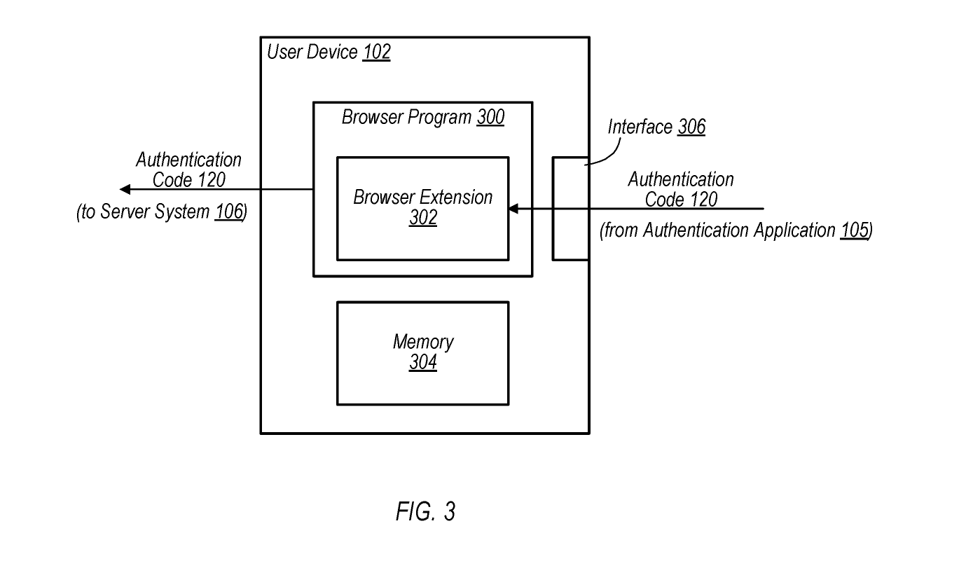

Authentication application 105 further includes authentication code generator 204. In various embodiments, authentication code generator 204 may be operable to generate authentication code 120 based on key 202 and one-time code 116. For example, in some embodiments, authentication code generator 204 may generate authentication code 120 by encrypting the one-time code 116 using key 202, where key 202 is a private key specific to the service for the user. Alternatively, in some embodiments, authentication system 108 may encrypt (e.g., using a public key) one-time code 116 prior to causing it to be sent to authentication application 105. In such embodiments, authentication code generator 204 may generate authentication code 120 by decrypting one-time code 116 using key 202 (e.g., a private key that corresponds to the public key used to encrypt one-time code 116). As described in more detail below with reference to FIGS. 3 and 4, authentication code 120 may be used as a secondary user authentication factor to authenticate the user to the service provided by server system 106.

Note that various authentication operations described herein (e.g., generating authentication code 120, generating recovered one-time code 416, etc.) may be performed using any suitable cryptographic algorithms. For example, in embodiments in which an asymmetric-key encryption scheme is used, authentication system 108 and authentication application 105 may use any suitable public key algorithm, such as RSA, Diffie-Hellman, ElGamal, or any other suitable algorithm.

Further, note that, in some embodiments, authentication application 105 may, after receiving one-time code 116, be operable to output this one-time code 116 to user device 102 as the authentication code 120. That is, in some embodiments, authentication application 105 may not perform any cryptographic operations on one-time code 116, instead having user device 102 send one-time code 116 back to authentication system 108 for verification. Such embodiments may provide various advantages, as discussed above. For example, even without performing any cryptographic operations on one-time code 116, for authentication system 108 to receive one-time code 116 from user device 102 (e.g., via server system 106) may still serve to authenticate the user by verifying that the user of user device 102 is in possession of authentication device 104 that is known to be associated with the authorized user. In some embodiments, for example, when registering to use the service provided by server system 106, the user of user device 102 may provide information corresponding to user device 102 or authentication device 104 (e.g., a telephone number, etc.) to server system 106, which may be shared with authentication system 108.

Referring now to FIG. 3, a block diagram illustrating an example user device 102 is depicted, according to some embodiments. User device 102 may be any suitable computing device (e.g., laptop computer, desktop computer, tablet computer, smart phone, etc.) that is operable to access a service provided by server system 106 and to send authentication codes 120 to server system 106 and/or authentication system 108 to maintain authentication of a user to that service.

In FIG. 3, user device 102 includes browser program 300, with browser extension 302, memory 304, and interface 306. In various embodiments, user device 102 may interact with the service provided by server system 106 via browser program 300. Browser program 300 may be any suitable web browser, such as Firefox™, Chrome™, Edge™, Safari™, etc., and the user may access the service by directing browser program 300 to a website hosted by server system 106. As noted above, server system 106 may require a user to provide certain credentials prior to accessing the service. Accordingly, the user may provide (e.g., via a web form of a web page hosted by server system 106), user credentials 110 to server system 106 upon attempting to access the service. In response to receiving these user credentials 110, server system 106 may generate and send authentication request 112 to authentication system 108. As discussed in more detail below, authentication system 108 may cause authentication message 114 to be sent to authentication application 105.

As noted above, authentication application 105 may be executed by either an authentication device 104 that is in communication with user device 102, or by user device 102 itself. In either embodiment, authentication application 105 may be operable to generate authentication code 120 using key 202 and one-time code 116, as discussed above. Once it has generated authentication code 120, authentication application 105 may output authentication code 120 such that it may be used to authenticate the user. For example, in one embodiment, authentication application 105 may store authentication code 120 in a specific memory location (e.g., a memory on authentication device 104 or on user device 102, such as memory 304). In such embodiments, browser extension 302 may be operable to retrieve authentication code 120. For example, in embodiments in which authentication device 104 and user device 102 are in communication via interface 306 (e.g., a USB 3.0 port, etc.), authentication application 105 may provide the authentication code 120 by storing it in a specified memory location (either on authentication device 104 or user device 102). Browser extension 302 may then retrieve the authentication code 120, which may be included in a request (e.g., http request) sent to server system 106 or authentication system 108 for validation. In various embodiments, these authentication operations may be repeatedly performed without requiring user input, thus improving secondary user authentication operations without negatively impacting the user experience of service provided by server system 106.

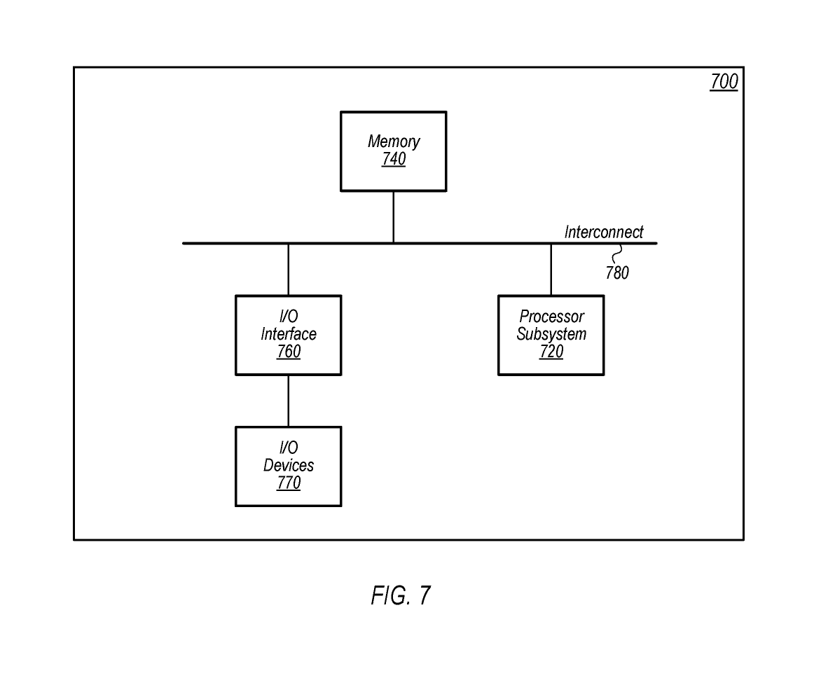

Note that the block diagram of user device 102 in FIG. 3 is simplified for clarity, and user device 102 may include any suitable combination of hardware or software components as described in more detail below with reference to FIG. 7. Further note that the disclosed embodiment utilizing browser program 300 and browser extension 302 is provided merely as an example and is not intended to limit the scope of this disclosure. In other embodiments, for example, user device 102 may access the service provided by server system 106 and/or send authentication codes 120 via one or more software programs (e.g., a service-specific software application) other than browser program 300 and browser extension 302.

Turning now to FIG. 4, a block diagram illustrating an example authentication system 108 is depicted, according to some embodiments. In various embodiments, authentication system 108 may be operable to repeatedly perform authentication operations to maintain authentication of a user of a service provided by server system 106.

As shown in FIG. 4, authentication system 108 may receive authentication request 112 from server system 106. For example, server system 106 may send authentication request 112 in response to a user of user device 102 attempting to access a service provided by server system 106. In various embodiments, authentication request 112 includes user information 410, which may specify the user attempting to access the service provided by server system 106, and service information 412, which may identify the service that is requesting authentication operations.

In FIG. 4, authentication system 108 includes key store 400. As noted above, in various embodiments, authentication system 108 and authentication application 105 may utilize pairs of keys as part of a cryptographic scheme to authenticate the user to the service provided by server system 106. Further, as noted above, authentication system 108 may, in some embodiments, perform authentication operations for various services, each of which may have numerous authorized users. Accordingly, in such embodiments, authentication system 108 may store (e.g., in key store 400) keys associated with these various users of these various services. In various embodiments, authentication system 108 may use user information 410 and service information 412 to retrieve a key 414 and key identifier 118 associated with the user for the particular service provided by server system 106.

Authentication system 108 further includes one-time code generator 402, which is operable to generate one-time codes 116. As described herein, authentication system 108 or authentication application 105 may perform cryptographic operations on one-time code 116 to authenticate the user of user device 102 to the service provided by server system 106. In various embodiments, a one-time code 116 may be a random or pseudo-random string. In such embodiments, one-time code generator 402 may utilize any suitable random or pseudo-random function to generate one-time codes 116. Additionally, in various embodiments, the one-time codes 116 utilized by system 100 may be longer than a typical one-time passcode that may be utilized in other systems. For example, were some systems may require a user to manually enter a six-digit passcode, one-time code 116 may be of any suitable length (e.g., hundreds of characters in length) and not necessarily constrained by a length that would be convenient for manual entry.

In various embodiments, authentication system 108 may be operable to cause authentication messages 114 to be sent to authentication application 105. Further, in various embodiments, a given authentication message 114 may include a one-time code 116 and a key identifier 118. Note that, as used herein, the phrase “causing an authentication message to be sent to authentication application” is to be interpreted broadly and is not intended to limit the present disclosure to only those embodiments in which authentication system 108 physically transmits authentication message 114. That is, while, in some embodiments, authentication system 108 may include hardware that is configured to transmit (e.g., via one or more cellular networks) authentication message 114 to authentication application 105, the present disclosure is not so limited. In other embodiments, for example, authentication system 108 may utilize a separate entity (e.g., a third-party service that sends one-time passcodes on behalf of various entities) to send authentication message 114. In such embodiments, authentication system 108 may be said to “cause an authentication message to be sent to an authentication application” by sending such a request to this separate entity, where the request specifies the key identifier 118 and one-time code 116.

Further, as shown in FIG. 4, authentication system 108 may receive authentication code 120. For example, as discussed above with reference to FIGS. 2 and 3, once authentication application 105 receives authentication message 114, it may use key identifier 118 and one-time code 116 to generate an authentication code 120. This authentication code 120 may then be sent, either directly or via server system 106, to authentication system 108. Authentication system 108 further includes code recovery module 404, which may be operable to use authentication code 120 and key 414 to generate recovered one-time code 416. For example, in some embodiments, authentication application 105 may be configured to encrypt one-time code 116 using key 202 of (e.g., a private key) to generate authentication code 120. In such embodiments, authentication system 108 may store, in key store 400, a corresponding key 414 (e.g., a corresponding public key), and code recovery module 404 may use key 414 to decrypt authentication code 120 to generate recovered one-time code 416.

Authentication system 108 further includes comparator 406. In various embodiments, comparator 406 may be operable to compare recovered one-time code 416 with the one-time code 116 that was sent to the authentication application 105 and generate authentication indication 122. In various embodiments, authentication indication 122 may be expressed as a Boolean value, numeric value, or in any other suitable format that specifies the outcome of the comparison performed by comparator 406. Authentication indication 122 may, in various embodiments, be provided to server system 106 and may indicate whether the user is authenticated to the service. For example, in response to recovered one-time code 416 matching one-time code 116, authentication indication 122 may indicate that the user is authenticated to the service for that authentication iteration. If, however, recovered one-time code 416 does not match one-time code 116, authentication indication 122 may indicate that the user is not authenticated to the service for that authentication iteration, and server system 106 or authentication system 108 may take one or more corrective actions, as discussed above.

Note, however, that the cryptographic scheme described with reference to code recovery module 404 and comparator 406 is simply provided as one example and is not intended to limit the scope of this disclosure. For example, in some alternate embodiments, authentication system 108 may, prior to causing authentication message 114 to be sent to authentication application 105, generate one-time code 116 by encrypting a particular value using a key 414 (e.g., a public key) associated with the user for that service. In such an embodiment, authentication application 105 may be configured to generate authentication code 120 by decrypting the one-time code 116 using a particular key 202 (e.g., a corresponding private key), and authentication system 108 may determine whether to authenticate the user by comparing (e.g., using comparator 406) the authentication code 120 to the particular value.

### Example Methods

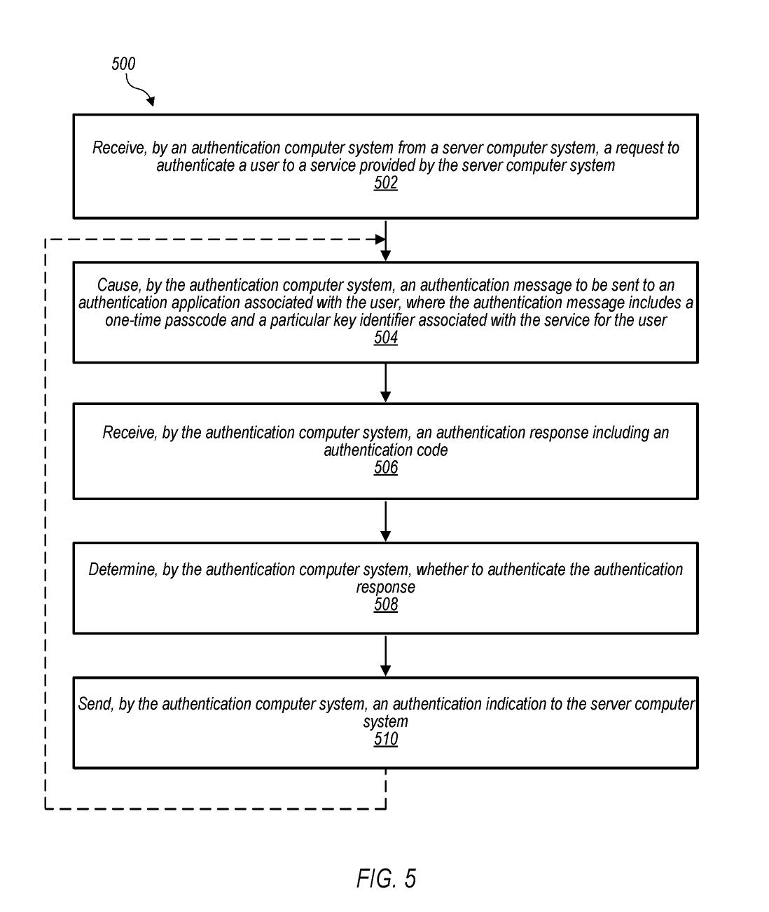

Referring now to FIG. 5, a flow diagram illustrating an example method 500 for performing repeated secondary user authentication is depicted, according to some embodiments. In various embodiments, method 500 may be performed, e.g., by authentication system 108 of FIG. 1, to authenticate a user of user device 102 to a service provided by server system 106.

In FIG. 5, method 500 includes elements 502-510. While these elements are shown in a particular order for ease of understanding, other orders may be used. In various embodiments, some of the method elements may be performed concurrently, in a different order than shown, or may be omitted. Additional method elements may also be performed as desired. Element 502 includes receiving, by an authentication computer system from a server computer system, a request to authenticate a user to a service provided by the server computer system. For example, authentication system 108 may receive authentication request 112 from server system 106, requesting that authentication system 108 authenticate a user of user device 102 to a service provided by server system 106.

Method 500 then proceeds to element 504, which includes causing, by the authentication computer system, an authentication message to be sent to an authentication application associated with the user, where the authentication message includes a one-time passcode and a particular key identifier associated with the service for the user. For example, authentication system 108 may cause authentication message 114 to be sent (e.g., via an SMS message) to authentication application 105 executing on authentication device 104 (e.g., a smartphone or dongle) or on user device 102. In various embodiments, the authentication message 114 is sent to the authentication application 105 out-of-band with respect to the service provided by server system 106.

Method 500 then proceeds to element 506, which includes receiving, by the authentication computer system, an authentication response including an authentication code. For example, after receiving authentication message 114, authentication application 105 may generate authentication code 120, which may be sent, via server system 106, to authentication system 108 as part of an authentication response. As noted above, authentication application 105 may, in some embodiments, generate the authentication code based on the one-time passcode and a particular key without user input. Method 500 then proceeds to element 508, which includes determining, by the authentication computer system, whether to authenticate the authentication response. For example, as described in more detail above with reference to FIG. 4, authentication system 108 may be configured to decrypt the authentication code 120 based on a public key associated with the user for the service to generate a decrypted authentication code, and to compare the decrypted authentication code with the one-time code 116 sent to the authentication application, according to some embodiments.

Method 500 then proceeds to element 510, which includes sending, by the authentication computer system, an authentication indication to the server computer system. For example, authentication system 108 may be configured to send authentication indication 122 to server system 106 based on the results of element 508. As shown in FIG. 5, elements 504-510 may be repeated, in at least some embodiments. For example, in some such embodiments, authentication system 108 may be configured to repeatedly cause updated authentication messages to be sent to the authentication application 105, where each of the authentication messages includes an updated one-time passcode. Further, in some such embodiments, the frequency with which authentication system 108 causes the updated authentication messages to be sent may be based on a security preference of the service provided by server system 106.

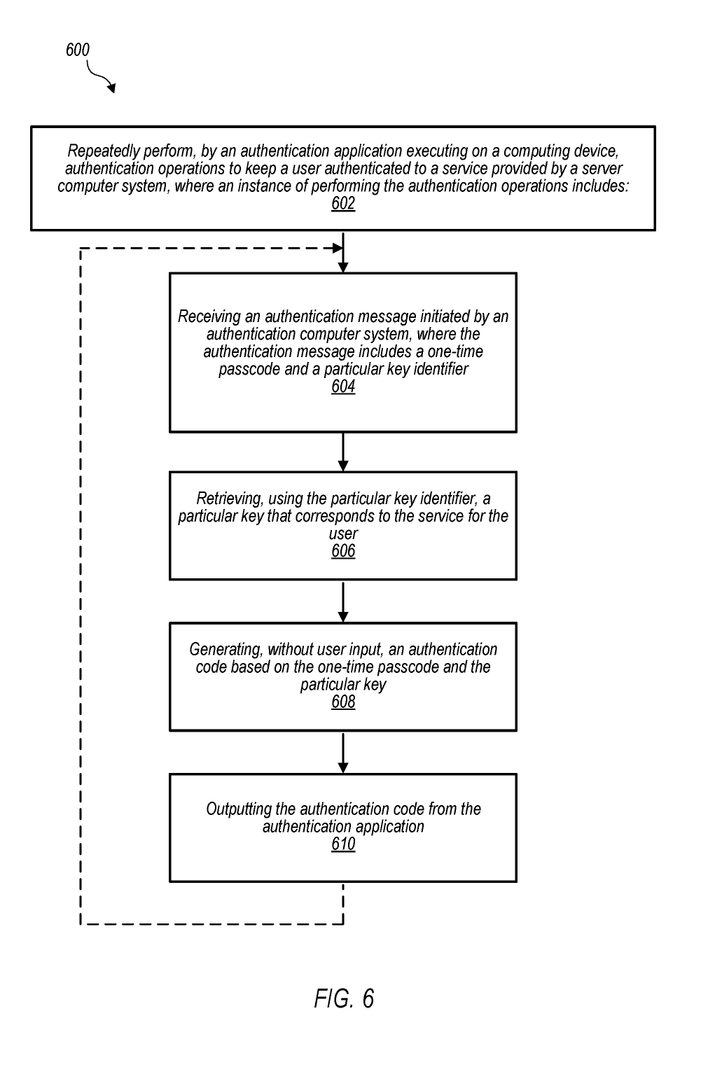

Turning now to FIG. 6, a flow diagram illustrating an example method 600 for keeping a user authenticated to a service provided by server system 106 is depicted, according to some embodiments. In various embodiments, method 600 may be performed, e.g., by authentication application 105 executing on authentication device 104 of FIG. 1. For example, in some embodiments, authentication device 104 may include at least one processor and a non-transitory, computer-readable medium having instructions stored thereon that are executable by the at least one processor to perform the operations described with reference to FIG. 6.

In FIG. 6, method 600 includes elements 602-610. While these elements are shown in a particular order for ease of understanding, other orders may be used. In various embodiments, some of the method elements may be performed concurrently, in a different order than shown, or may be omitted. Additional method elements may also be performed as desired. Element 602 includes repeatedly performing, by an authentication application executing on a computing device, authentication operations to keep a user authenticated to a service provided by a server computer system. In some embodiments, the computing device is in communication with a separate user device by which the service is provided to the user. That is, in some embodiments, the authentication application 105 may be executing on an authentication device 104 (e.g., a smart phone or dongle) that is separate from and in communication with the user device 102 (e.g., a laptop computer, desktop computer, etc.) by which the service is provided to the user. For example, authentication device 104 may include an interface (e.g., a USB interface) and be configured to communicate, via the interface, with the separate user device 102. In other embodiments, however, the computing device is in communication with the server computer system by which the service is provided to the user. That is, in some such embodiments, authentication application 105 may be executing on the user device 102 (e.g., a smart phone or other computing device that includes a wireless interface) by which the service is provided to the user.

Further, in some embodiments, an instance of performing these authentication operations includes the operations shown in elements 604-610. Element 604 includes receiving an authentication message initiated by an authentication computer system, where the authentication message includes a one-time passcode and a particular key identifier. For example, as discussed above, the computing device on which authentication application 105 is executing (whether it be user device 102 or an authentication device 104 that is separate from user device 102) includes a wireless interface that is configured to receive authentication messages 114 initiated by authentication system 108. In various embodiments, the authentication message is sent to the authentication application 105 out-of-band with respect to the service provided by the server system 106 to the user. For example, the service may be provided by the server system 106 via a first communication system (e.g., over the Internet) and the authentication message 114 may be received via a second communication system that includes a cellular network (e.g., as part of an SMS message).

Method 600 then proceeds to element 606, which includes retrieving, using the particular key identifier, a particular key that corresponds to the service for the user. For example, authentication application 105 may have access to multiple keys (e.g., stored on authentication device 104) that are usable to authenticate the user to multiple services. In such embodiments, authentication application 105 may use the particular key identifier to identify and retrieve the particular key that corresponds to the service to which the user is being authenticated.

Method 600 then proceeds to element 608, which includes generating, without user input, an authentication code based on the one-time passcode and the particular key. For example, as described above with reference to FIG. 2, authentication application 105 may, in some embodiments, generate the authentication code by encrypting the one-time passcode using the particular key, where the particular key is a private key specific to the service for the user. In such embodiments, the authentication system 108 may authenticate the user by decrypting the authentication code based on a public key associated with the user for the service to generate a decrypted authentication code, and then compare the decrypted authentication code to the one-time passcode to determine whether to authenticate the user. In other embodiments, however, the authentication system 108 may encrypt a particular value based on a public key associated with the user for the service to generate the one-time code 116 prior to causing the authentication message 114 to be sent to authentication application 105. In such embodiments, element 608 may include decrypting the one-time passcode using the particular key, where the particular key is a private key that corresponds to the public key used by the authentication system 108 to generate the one-time passcode.

In still other embodiments, authentication application 105 and authentication server 108 may utilize a symmetric key encryption scheme, in which authentication application 105 encrypts one-time code 116 using a shared key to generate authentication code 120. In such embodiments, authentication system 108 may validate authentication code 120 by encrypting one-time code 116 using the same shared key (and the same encryption technique(s)) as authentication application 105, and compare the authentication code 120 with the encrypted version of one-time code 116.

Method 600 then proceeds to element 610, which includes outputting the authentication code from the authentication application. For example, in some embodiments in which authentication application 105 is executing on an authentication device 104 that is separate from the user device 102, outputting the authentication code includes providing the authentication code (e.g., via a bus interface, NFC communications, Bluetooth, etc.) from the dongle to the separate user device 102 by which the service is provided to the user.

### Example Computer System

Referring now to FIG. 7, a block diagram of an example computer system 700 is depicted, which may implement one or more computer systems, such as user device 102 or authentication system 108 of FIG. 1, according to various embodiments. Computer system 700 includes a processor subsystem 720 that is coupled to a system memory 740 and I/O interfaces(s) 760 via an interconnect 780 (e.g., a system bus). I/O interface(s) 760 is coupled to one or more I/O devices 770. Computer system 700 may be any of various types of devices, including, but not limited to, a server system, personal computer system, desktop computer, laptop or notebook computer, mainframe computer system, server computer system operating in a datacenter facility, tablet computer, handheld computer, workstation, network computer, etc. Although a single computer system 700 is shown in FIG. 7 for convenience, computer system 700 may also be implemented as two or more computer systems operating together.

Processor subsystem 720 may include one or more processors or processing units. In various embodiments of computer system 700, multiple instances of processor subsystem 720 may be coupled to interconnect 780. In various embodiments, processor subsystem 720 (or each processor unit within 720) may contain a cache or other form of on-board memory.

System memory 740 is usable to store program instructions executable by processor subsystem 720 to cause system 700 perform various operations described herein. System memory 740 may be implemented using different physical, non-transitory memory media, such as hard disk storage, floppy disk storage, removable disk storage, flash memory, random access memory (RAM-SRAM, EDO RAM, SDRAM, DDR SDRAM, RAMBUS RAM, etc.), read only memory (PROM, EEPROM, etc.), and so on. Memory in computer system 700 is not limited to primary storage such as system memory 740. Rather, computer system 700 may also include other forms of storage such as cache memory in processor subsystem 720 and secondary storage on I/O devices 770 (e.g., a hard drive, storage array, etc.). In some embodiments, these other forms of storage may also store program instructions executable by processor subsystem 720.

I/O interfaces 760 may be any of various types of interfaces configured to couple to and communicate with other devices, according to various embodiments. In one embodiment, I/O interface 760 is a bridge chip (e.g., Southbridge) from a front-side to one or more back-side buses. I/O interfaces 760 may be coupled to one or more I/O devices 770 via one or more corresponding buses or other interfaces. Examples of I/O devices 770 include storage devices (hard drive, optical drive, removable flash drive, storage array, SAN, or their associated controller), network interface devices (e.g., to a local or wide-area network), or other devices (e.g., graphics, user interface devices, etc.). In one embodiment, I/O devices 770 includes a network interface device (e.g., configured to communicate over WiFi, Bluetooth, Ethernet, etc.), and computer system 700 is coupled to a network via the network interface device.

Although the embodiments disclosed herein are susceptible to various modifications and alternative forms, specific embodiments are shown by way of example in the figures and are described herein in detail. It should be understood, however, that figures and detailed description thereto are not intended to limit the scope of the claims to the particular forms disclosed. Instead, this application is intended to cover all modifications, equivalents and alternatives falling within the spirit and scope of the disclosure of the present application as defined by the appended claims. The headings used herein are for organizational purposes only and are not meant to be used to limit the scope of the description.

This disclosure includes references to “one embodiment,” “a particular embodiment,” “some embodiments,” “various embodiments,” “an embodiment,” etc. The appearances of these or similar phrases do not necessarily refer to the same embodiment. Particular features, structures, or characteristics may be combined in any suitable manner consistent with this disclosure.

As used herein, the term “based on” is used to describe one or more factors that affect a determination. This term does not foreclose the possibility that additional factors may affect the determination. That is, a determination may be solely based on specified factors or based on the specified factors as well as other, unspecified factors. Consider the phrase “determine A based on B.” This phrase specifies that B is a factor that is used to determine A or that affects the determination of A. This phrase does not foreclose that the determination of A may also be based on some other factor, such as C. This phrase is also intended to cover an embodiment in which A is determined based solely on B. As used herein, the phrase “based on” is synonymous with the phrase “based at least in part on.”

As used herein, the phrase “in response to” describes one or more factors that trigger an effect. This phrase does not foreclose the possibility that additional factors may affect or otherwise trigger the effect. That is, an effect may be solely in response to those factors, or may be in response to the specified factors as well as other, unspecified factors. Consider the phrase “perform A in response to B.” This phrase specifies that B is a factor that triggers the performance of A. This phrase does not foreclose that performing A may also be in response to some other factor, such as C. This phrase is also intended to cover an embodiment in which A is performed solely in response to B.

As used herein, the terms “first,” “second,” etc. are used as labels for nouns that they precede, and do not imply any type of ordering (e.g., spatial, temporal, logical, etc.), unless stated otherwise. When used in the claims, the term “or” is used as an inclusive or and not as an exclusive or. For example, the phrase “at least one of x, y, or z” means any one of x, y, and z, as well as any combination thereof (e.g., x and y, but not z).

It is to be understood that the present disclosure is not limited to particular devices or methods, which may, of course, vary. It is also to be understood that the terminology used herein is for the purpose of describing particular embodiments only, and is not intended to be limiting. As used herein, the singular forms “a,” “an,” and “the” include singular and plural referents unless the context clearly dictates otherwise. Furthermore, the word “may” is used throughout this application in a permissive sense (i.e., having the potential to, being able to), not in a mandatory sense (i.e., must). The term “include,” and derivations thereof, mean “including, but not limited to.” The term “coupled” means directly or indirectly connected.

Within this disclosure, different entities (which may variously be referred to as “units,” “circuits,” other components, etc.) may be desciibed or claimed as “configured” to perform one or more tasks or operations. This formulation [entity] configured to [perform one or more tasks] is used herein to refer to structure (i.e., something physical, such as an electronic circuit). More specifically, this formulation is used to indicate that this structure is arranged to perform the one or more tasks during operation. A structure can be said to be “configured to” perform some task even if the structure is not currently being operated. A “memory device configured to store data” is intended to cover, for example, an integrated circuit that has circuitry that performs this function during operation, even if the integrated circuit in question is not currently being used a power supply is not connected to it). Thus, an entity described or recited as “configured to” perform some task refers to something physical, such as a device, circuit, memory storing program instructions executable to implement the task, etc. This phrase is not used herein to refer to something intangible.

The term “configured to” is not intended to mean “configurable to.” An unprogrammed FPGA, for example, would not be considered to be “configured to” perform some specific function, although it may be “configurable to” perform that function after programming.

Reciting in the appended claims that a structure is “configured to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke Section 112(f) during prosecution, it will recite claim elements using the “means for” [performing a function] construct.

In this disclosure, various “modules” configured to perform designated functions are shown in the figures and described in detail above (e.g., authentication code generator 204, code recovery module 404, comparator 406, etc.). As used herein, the term “module” refers to circuitry configured to perform specified operations or to physical, non-transitory computer-readable media that stores information (e.g., program instructions) that instructs other circuitry (e.g., a processor) to perform specified operations. Such circuitry may implemented in multiple ways, including as a hardwired circuit or as a memory having program instructions stored therein that are executable by one or more processors to perform the operations. The hardware circuit may include, for example, custom very-large-scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, or the like. A module may also be any suitable form of non-transitory computer readable media storing program instructions executable to perform specified operations.

Although specific embodiments have been described above, these embodiments are not intended to limit the scope of the present disclosure, even where only a single embodiment is described with respect to a particular feature. Examples of features provided in the disclosure are intended to be illustrative rather than restrictive unless stated otherwise. The above description is intended to cover such alternatives, modifications, and equivalents as would be apparent to a person skilled in the art having the benefit of this disclosure.

The scope of the present disclosure includes any feature or combination of features disclosed herein (either explicitly or implicitly), or any generalization thereof, whether or not it mitigates any or all of the problems addressed herein. Accordingly, new claims may be formulated during prosecution of this application (or an application claiming priority thereto) to any such combination of features. In particular, with reference to the appended claims, features from dependent claims may be combined with those of the independent claims and features from respective independent claims may be combined in any appropriate manner and not merely in the specific combinations enumerated in the appended claims.

What is claimed is:

1. A method, comprising:
receiving, by an authentication computer system from a server computer system, a request to authenticate a user to a service provided by the server computer system;
causing, by the authentication computer system, an authentication message to be sent to an authentication application associated with the user, wherein the authentication message includes a one-time passcode and a particular key identifier associated with the service for the user, and wherein the authentication message is sent to the authentication application out-of-band with respect to the service provided by the server computer system to the user;
receiving, by the authentication computer system, an authentication response including an authentication code, wherein the authentication code is generated, without user input, by the authentication application based on the one-time passcode and a particular key associated with the user for the service;
determining, by the authentication computer system, whether to authenticate the authentication response; and
sending, by the authentication computer system, an authentication indication to the server computer system.

2. The method of claim 1, wherein the authentication computer system is configured to repeatedly cause updated authentication messages to be sent to the authentication application, wherein each of the updated authentication messages includes an updated one-time passcode.

3. The method of claim 2, wherein a frequency with which the updated authentication messages are sent to the authentication application is based on a security preference of the service.

4. The method of claim 1, wherein the authentication application is executing on an authentication device in communication with a separate user device by which the user is accessing the service provided by the server computer system.

5. The method of claim 1, wherein the authentication application is executing on a user device by which the user is accessing the service provided by the server computer system, wherein the user device includes a wireless interface operable to receive the authentication message.

6. The method of claim 1, wherein the determining whether to authenticate the authentication response comprises:
decrypting, by the authentication computer system, the authentication code based on a public key associated with the user for the service to generate a decrypted authentication code, wherein the public key corresponds to a private key used to generate the authentication code; and
comparing, by the authentication computer system, the decrypted authentication code to the one-time passcode in order to determine whether to authenticate the authentication response.

7. The method of claim 1, further comprising:
prior to causing the authentication message to be sent to the authentication application, encrypting a particular value based on a public key associated with the user for the service to generate the one-time passcode; and
wherein the determining whether to authenticate the authentication response is based on comparing the authentication code to the particular value.

8. The method of claim 1, wherein the authentication message is sent to the authentication application via a wireless text message that is out-of-band with respect to the service provided by the server computer system to the user.

9. A method, comprising:
repeatedly performing, by an authentication application executing on a computing device, authentication operations to keep a user authenticated to a service provided by a server computer system, wherein an instance of performing the authentication operations includes:
receiving an authentication message initiated by an authentication computer system, wherein the authentication message is out-of-band with respect to the service provided to the user, and wherein the authentication message includes a one-time passcode and a particular key identifier, wherein the particular key identifier specifies the service for the user;
retrieving, using the particular key identifier, a particular key that corresponds to the service for the user;
generating, without user input, an authentication code based on the one-time passcode and the particular key; and
outputting the authentication code from the authentication application.

10. The method of claim 9, wherein the computing device is in communication with a separate user device by which the service is provided to the user.

11. The method of claim 9, wherein the computing device is in communication with the server computer system by which the service is provided to the user.

12. The method of claim 9, wherein the generating the authentication code comprises encrypting the one-time passcode using the particular key, wherein the particular key is a private key specific to the service for the user.

13. The method of claim 9, wherein the generating the authentication code comprises decrypting the one-time passcode using the particular key, wherein the particular key is a private key that corresponds to a public key used by the authentication computer system to generate the one-time passcode.

14. The method of claim 9, wherein the service is provided by the server computer system via a first communication system; and wherein the authentication message is received via a second communication system that includes a cellular network.

15. The method of claim 9, wherein the authentication message is received as part of an SMS message, wherein the computing device is a dongle, and wherein the outputting the authentication code from the authentication application comprises providing the authentication code, via a bus interface, from the dongle to a separate user device by which the service is provided to the user.

16. An authentication device, comprising:
a wireless interface configured to receive a plurality of authentication messages initiated by an authentication computer system;
at least one processor; and
a non-transitory, computer-readable medium having instructions stored thereon that are executable by the at least one processor to perform operations, the operations comprising:
repeatedly performing, by an authentication application executing on the authentication device, authentication operations to keep a user authenticated to a service provided by a server computer system, wherein an instance of performing the authentication operations includes:
receiving, via the wireless interface, an authentication message initiated by the authentication computer system, wherein the authentication message is out-of-band with respect to the service provided to the user, and wherein the authentication message includes a one-time passcode and a particular key identifier, wherein the particular key identifier specifies the service for the user;
retrieving, using the particular key identifier, a particular key that corresponds to the service for the user;
generating, without user input, an authentication code based on the one-time passcode and the particular key; and
outputting the authentication code from the authentication application.

17. The authentication device of claim 16, further comprising:
a bus interface, wherein the authentication device is configured to communicate, via the bus interface, with a separate user device by which the service is provided to the user.

18. The authentication device of claim 16, wherein the generating the authentication code comprises encrypting the one-time passcode using the particular key, wherein the particular key is a private key specific to the service for the user.

19. The authentication device of claim 16, wherein the generating the authentication code comprises decrypting the one-time passcode using the particular key, wherein the particular key is a private key that corresponds to a public key used by the authentication computer system to generate the one-time passcode.

20. The authentication device of claim 16, wherein the non-transitory, computer-readable medium further stores a plurality of keys, including the particular key, that correspond to a plurality of services.
